(19) United States
(12) Patent Application Publication
(10) Pub. No.: US 2009/0020626 A1
(43) Pub. Date: Jan. 22, 2009

(54) SHAPING AIR AND BELL CUP COMBINATION

(75) Inventor: David M. Seitz, Riga, MI (US)

Correspondence Address: BARNES & THORNBURG LLP, 11 SOUTH MERIDIAN, INDIANAPOLIS, IN, 46204, US

(73) Assignee: ILLINOIS TOOL WORKS INC., Glenview, IL (US)

(21) Appl. No.: 11/778,393

(22) Filed: Jul. 16, 2007

(51) Int. Cl. B05B 9/03

(52) U.S. Cl. 239/332; 239/338; 239/346

(57) ABSTRACT

A coating material dispensing apparatus comprising a bell cup and a motor for rotating the bell cup about an axis of rotation of the bell cup. The motor is housed in a housing. A conduit is provided for feeding coating material to the interior of the bell cup as the bell cup is rotated by the motor. The coating material flows to an edge of the bell cup and is atomized therefrom in accordance with known principles. The housing includes an annular slot formed around the bell cup edge. Compressed air is coupled to the annular slot to generate and direct a first air stream at an exterior of the bell cup. At least one additional opening is formed in the housing radially outwardly from the annular slot. Compressed air is also coupled to the at least one additional opening to generate and direct a second air stream to combine with the first air stream to provide an air band.

### FIELD OF THE INVENTION

This invention relates to atomizers. It is disclosed in the context of a rotary atomizer for atomizing fluent coating material, such as liquid or fluidized powder coating material, but it may be useful in other applications as well.

### BACKGROUND OF THE INVENTION

Various types of atomizers for atomizing and dispensing fluent coating materials are known. There are, for example, the atomizers are illustrated and described in, for example, U.S. Pat. Nos. 2,890,388; 2,960,273; 3,393,662; 3,408,985; 3,536,514; 3,575,344; 3,608,823; 3,698,636; 3,843,054; 3,913,523; 3,952,951; 3,964,683; 4,037,561; 4,114,564; 4,114,810; 4,135,667; 4,143,819; 4,216,915; 4,228,961; 4,381,079; 4,447,008; 4,450,785; Re. 31,867; 4,760,965; 4,771,949; 4,784,331; 4,788,933; 4,802,625; 4,811,898; 4,852,810; 4,872,616; 4,943,005; 4,955,960; 4,997,130; 5,085,373; 5,353,995; 5,433,387; 5,582,347; 5,622,563; 5,633,306; 5,662,278; 5,697,559; 5,720,436; 5,803,372; 5,853,126; 5,862,988; 5,957,395; 6,006,999; 6,012,657; 6,042,030; 6,053,428; 6,076,751; 6,230,993; 6,328,224; 6,676,049; 6,991,178; published U.S. patent applications: US 2004/0061007; US 2005/0035229; and WO 03/031075. There are also the devices illustrated and described in U.S. Pat. Nos. 2,759,763; 2,877,137; 2,955,565; 2,996,042; 3,589,607; 3,610,528; 3,684,174; 4,066,041; 4,171,100; 4,214,708; 4,215,818; 4,323,197; 4,350,304; 4,402,991; 4,422,577; Re. 31,590; 4,518,119; 4,726,521; 4,779,805; 4,785,995; 4,879,137; 4,890,190; 5,011,086; 5,058,812: and, 4,896,384; British Patent Specification 1,209,653; Japanese published patent applications: 62-140,660; 1-315,361; 3-169,361; 3-221,166; 08-099,053; 08-108,103; 08-131,902; 08-196,945; 08-196946; 20-0005645; 60-151,554; 60-94,166; 63-116,776; PCT/JP2005/018045; and 58-124,560; and, French patent 1,274,814. There are also the devices illustrated and described in “Aerobell™ Powder Applicator ITW Automatic Division;” “Aerobell™ & Aerobell Plus™ Rotary Atomizer, DeVilbiss Ransburg Industrial Liquid Systems;” and, “Wagner PEM-C3 Spare parts list.”

### DISCLOSURE OF THE INVENTION

According to the invention, a coating material dispensing apparatus comprises a bell cup and a motor for rotating the bell cup about an axis of rotation of the bell cup. The motor is housed in a housing. A conduit is provided for feeding coating material to the interior of the bell cup as the bell cup is rotated by the motor. The coating material flows to an edge of the bell cup and is atomized therefrom. The housing includes an annular slot formed around the bell cup edge. Compressed air is coupled to the annular slot to generate and direct a first air stream at an exterior of the bell cup. At least one additional opening is formed in the housing radially outwardly from the annular slot. Compressed air is coupled to the at least one additional opening to generate and direct a second air stream to combine with the first air stream to provide an air band.

Illustratively, the at least one opening comprises a second annular slot.

Alternatively illustratively, the at least one opening comprises an annular array of holes.

### BRIEF DESCRIPTION OF THE DRAWINGS

The invention may best be understood by referring to the following detailed description and accompanying drawings which illustrate the invention. In the drawings:

FIG. 1 illustrates a partly fragmentary, partly broken away and partly diagrammatic side elevational view of an apparatus constructed according to the invention;

FIG. 2 illustrates a front perspective of an alternative detail to certain details illustrated in FIG. 1;

FIG. 3 illustrates a perspective view, from the front, of certain details of the apparatus illustrated in FIG. 1; and,

FIGS. 4a-c illustrate details of the operation of apparatus constructed according to the invention.

### DETAILED DESCRIPTION

One of the typical problems with any spray pattern formed by a rotary atomizer is the inability to control the entire range of particle sizes being created. While considerable effort has been directed over the years toward achieving uniformity in particle size range, see, for example, U.S. Pat. No. 4,148,932, size variation is virtually inevitable. Typically the larger, more massive particles are less affected by shaping air methods and electrostatic forces. These particles have been known to form what is sometimes called a “ghost” pattern, a distinct visually observable spray pattern formed on the article being coated (hereinafter sometimes the “target”) during the coating application adjacent the primary spray pattern.

The lighter, smaller particles tend generally to be affected by shaping air and electrostatic forces and move more directly toward the article to be coated, and the larger particles tend to be somewhat less affected by shaping air and electrostatic forces and, as a result, continue to move radially outward from the bell cup after atomization. The less affected of these higher mass particles can deposit on places other than the article to be coated. Coating booth walls and ceilings, coating robots, robot housings and even components of the coating atomizer itself can become coated with these stray particles. Other high mass particles slightly more affected by shaping air and electrostatic forces may form the ghost, a lower density ring adjacent the higher density deposit of lower mass particles most affected by shaping air and electrostatic forces. The illustrated and described systems tend to incorporate more of the higher mass particles into the main stream of lower mass particles forming the bulk of the pattern. This helps keep the surrounding areas clean. It also tends to increase the overall transfer efficiency of coating material from the atomizer to the article to be coated.

It is known that air leaving an orifice expands at a certain angle. By appropriately spacing the orifices behind the atomizing edge of a bell cup, one can increase or decrease the effect of the shaping air stream on the coating material particles dispensed from the edge of the bell cup. Generally, the longer a coating material particle is in the shaping air stream, the better the chances are of the coating material particle's path being influenced by the shaping air stream, changing the coating material particle's path from the radial direction in which it is discharged from the bell cup's atomizing edge to a more desirable forward direction toward the target. The proper relationship must be maintained between the particles being discharged from the bell cup and the band of shaping air. If the shaping air band is too close to the edge of the bell cup, the air tends to pass through the particles having only a limited effect, generally on the smaller, that is, less massive particles.

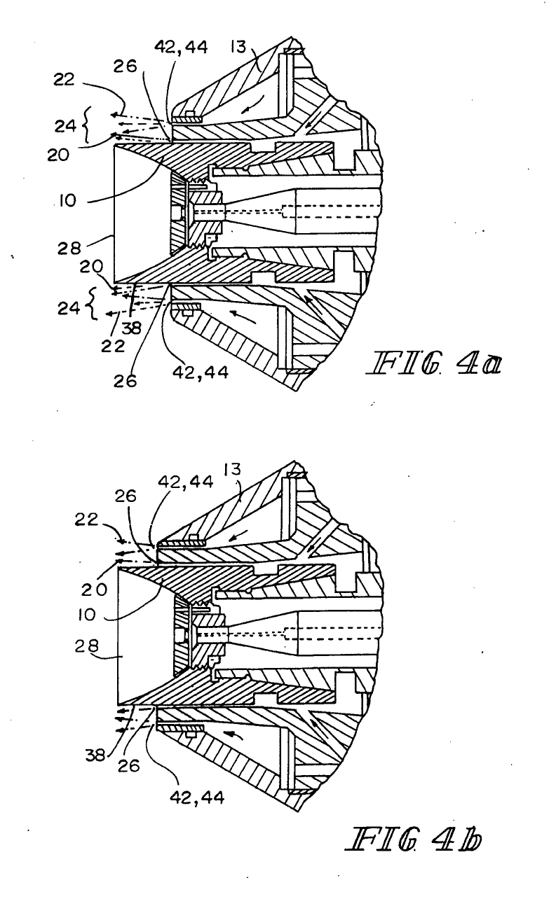

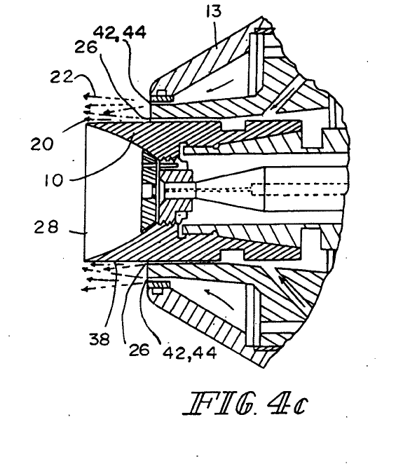

A coating material dispensing apparatus includes a bell cup 10. The bell cup 10 is mounted on the output shaft of a motor 11, for example, a compressed gas turbine motor, for rotating the bell cup 10 about an axis of rotation of the bell cup 10. The motor 11 is conventionally housed in a housing 13. Coating material to supplied from a coating material source 15 through a conduit 17 to the interior of the bell cup 10 as the bell cup 10 is rotated by the motor 11. The coating material flow in a known manner to an edge 28 of the bell cup 10 and being atomized therefrom. The housing 13 includes an annular slot 26 formed around the bell cup edge 28. Compressed air is coupled from a compressed air source 29 through the housing 13 to the annular slot 26 to generate and direct a first air stream 20 (shown only at the top in FIGS. 4b-c) at an exterior 38 of the bell cup 10. At least one additional opening 42, 44 is formed in the housing 13 radially outwardly from the annular slot 26. Compressed air from source 29 or another suitable source (not shown) is coupled to the at least one additional opening 42, 44 to generate and direct a second air stream 22 (shown only at the top in FIGS. 4b-c) to combine with the first air stream 20 to provide an air band 24.

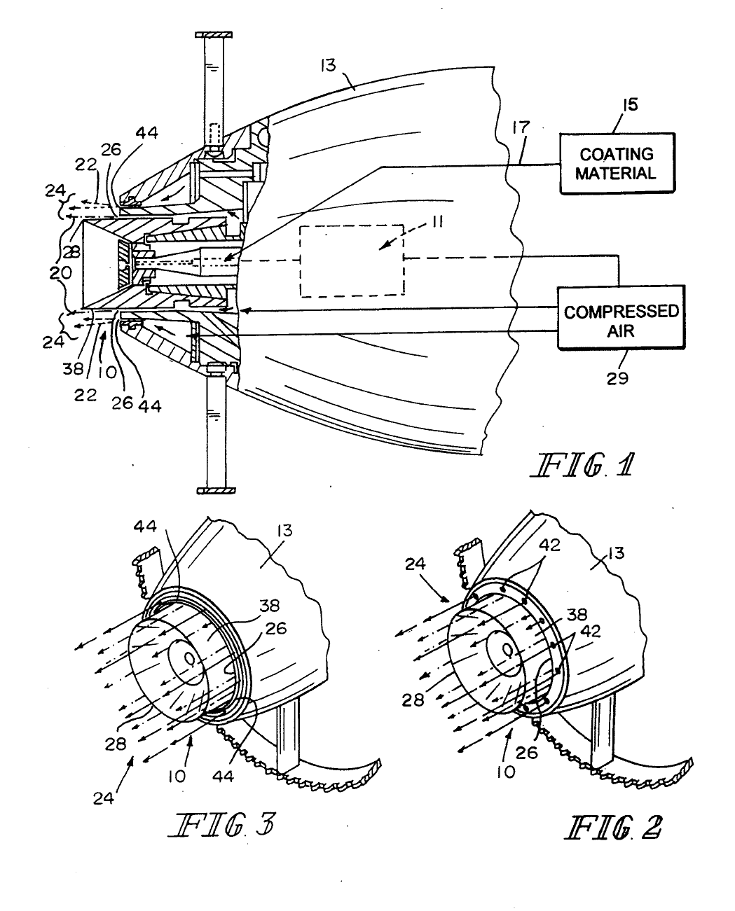

The illustrated embodiments incorporate two air streams 20, 22 to increase the width of the air band 24. In the embodiment illustrated in FIG. 2, the first air stream 20 issues from an annulus 26 formed around the bell cup edge 28. The second air stream 22 issues from a plurality of holes 42 spaced radially outward from the annulus 26. The spacing of the set of holes 42 in relationship to the annulus 26 and also in relationship to the bell cup edge 28 increases the flexibility in the location of the shaping air band 24 by which the particles of coating material being atomized from edge 28 are influenced. A variety of relationships between the first air stream 20, the second air stream 22 and the bell cup edge 28 are possible. Forming the first air stream 20 as an annulus provides a complete, full air pattern adjacent the bell cup edge 28. That is, no voids or gaps are formed in the compressed air stream issuing from annulus 26, as can happen when an air stream is provided by a plurality of holes, owing to the spacings between adjacent holes. It is believed that this first air stream 20 also stays against the exterior surface 38 of the bell cup 10 better than an air stream generated by holes having walls between them. The second air stream 22 can be generated by a plurality of holes 42, but, as illustrated in FIGS. 1 and 3, can also be generated by an annular opening 44, similar to annulus 26.

Referring now to FIGS. 4a-c, air exiting a planar opening through a pressure differential or drop across the opening in the range of less than or equal to about 100 p. s. i. (about 690 KPa) or so, whether a circular- or other cross-section hole or annular opening, expands at an angle in the range of about 7° to a perpendicular to the plane of the opening, from the edge(s) of the opening. Thus, the air issuing from annulus 26 will spread at an angle in the range of about 7° from the outer edge of annulus 26. Of course, the air issuing from annulus 26 will be kept from spreading inwardly toward the axis of bell cup 10 by the forwardly extending outer sidewall 38 of bell cup 10 until the air reaches the forward edge 28 of bell cup 10. The air issuing from holes 42 or annulus 44 will spread at an angle in the range of about 2×7°, or 14°, owing to the two diametrically opposite edges of each hole 42 and annulus 44.

In the present case, how narrow or wide the air band 24 is to be helps to determine how close or how far away from the bell cup edge the opening(s) 26, 42, 44 need(s) to be placed.

Additionally, all other parameters being equal, the closer to the opening(s) 26, 42, 44 are to the bell cup edge 28, of course, the higher the air velocity will be at edge 28. The further the bell cup edge 28 is from the opening(s) 26, 42, 44, the lower the air velocity will be at the bell cup edge 28. The diameter(s) and radial width(s) of the annulus 26 (annuli 26, 44), the hole 42 size, and the distance from the first annulus 26 to the second annulus 44 or set of holes 42 also affect the band 24 width.

The effects of these variables can best be appreciated by referring to FIGS. 4a-c. In FIGS. 4a-c, the bell cup 10 is an ITW Industrial Finishing 1 inch (about 2.54 cm) diameter Microbell™ bell cup 10. Illustratively, the annular gap between the outside surface 38 of the cup 10 and the inside surface of the housing 13 is about 0.020 inch (about 0.5 mm). Where an annular opening 44 is employed, its width radially of the housing 13 and bell cup 10 axis of rotation illustratively is also about 0.020 inch (about 0.5 mm). Where holes 42 are employed, the holes illustratively are circular in cross section, 0.026-0.027 inch (about 0.66-0.69 mm) in diameter, and forty in number, equally circumferentially spaced at 9° intervals about the bell cup 10 axis of rotation.

FIG. 4a illustrates a configuration in which the air streams 20, 22 issuing from openings 26 and 42 or 44 spread at angles in the range of about 7° from each edge and merge at edge 28. In FIG. 4a, the spacing between the surface in which openings 26 and 42 or 44 are provided and the edge 28 of bell cup 10 is about 0.5 inch (about 1.27 cm).

FIG. 4b illustrates a configuration in which the air streams 20, 22 issuing from openings 26 and 42 or 44 spread at angles in the range of about 7° from each edge, but have not yet merged when they reach edge 28. This can be corrected by: (1) moving the surface in which openings 26 and 42 or 44 are provided rearward; (2) by increasing the surface areas of openings 26 and/or 42 or 44; and/or, (3) by reducing the spacing between opening 26 and opening(s) 42 or 44. In FIG. 4b, the spacing between the surface in which openings 26 and 42 or 44 are provided and the edge 28 of bell cup 10 is about 0.35 inch (about 0.89 cm).

FIG. 4c illustrates a configuration in which the air streams issuing from openings 26 and 42 or 44 spread at angles in the range of about 7° from each edge, but merge before they reach edge 28. This can be corrected by: (1) moving the surface in which openings 26 and 42 or 44 are provided forward; (2) by decreasing the surface areas of openings 26 and/or 42 or 44; and/or, (3) by increasing the spacing between opening 26 and opening(s) 42 or 44. In FIG. 4c, the spacing between the surface in which openings 26 and 42 or 44 are provided and the edge 28 of bell cup 10 is about 0.56 inch (about 1.42 cm).

The illustrated embodiments thus more easily achieve pattern control, a more uniform pattern, better transfer efficiency with less solvent usage and paint usage, less overspray leading to cleaner equipment, surrounding environment and total environment, the capability to provide a smaller pattern for recessed areas and the like in articles to be coated, and less manual cleaning and resulting downtime.

What is claimed is:

1. A coating material dispensing apparatus comprising a bell cup, a motor for rotating the bell cup about an axis of rotation of the bell cup, the motor housed in a housing, a conduit for feeding coating material to the interior of the bell cup as the bell cup is rotated by the motor, the coating material flowing to an edge of the bell cup and being atomized therefrom, the housing including an annular slot formed around the bell cup edge, compressed air coupled to the annular slot to generate and direct a first air stream at an exterior of the bell cup, at least one additional opening formed in the housing radially outwardly from the annular slot, compressed air being coupled to the at least one additional opening to generate and direct a second air stream to combine with the first air stream to provide an air band.

2. The apparatus of claim 1 wherein the at least one opening comprises a second annular slot.

3. The apparatus of claim 1 wherein the at least one opening comprises an annular array of holes.
